(19) United States
(12) Patent Application Publication
(10) Pub. No.: US 2006/0069004 A1
(43) Pub. Date: Mar. 30, 2006

(54) Method of cleaning dishware using automatic dishwashing detergent compositions containing potassium tripolyphosphate formed by in-situ hydrolysis

(75) Inventors: Brian Xiaoqing Song, Mason, OH (US); Frank William DeNome, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/227,365

(22) Filed: Sep. 15, 2005

Related U.S. Application Data
(60) Provisional application No. 60/613,694, filed on Sep. 28, 2004.

(51) Int. Cl. C11D 3/39

(52) U.S. Cl. 510/220; 510/510

(57) ABSTRACT

Methods of improving dishware cleaning performance using economical, substantially sodium ion-free, aqueous ADW detergent compositions and compositions of matter, having potassium tripolyphosphate that is prepared by in-situ hydrolysis is provided.

### CROSS REFERENCE TO RELATED APPLICATION

This application claims the benefit of U.S. Provisional Application No. 60/613,694, filed Sep. 28, 2004.

### FIELD OF THE INVENTION

The present invention relates to methods of improving dishware cleaning performance using an economical, aqueous automatic dishwashing (ADW) detergent composition having good dispensability and product clarity. More particularly, the present invention relates to use of substantially sodium ion-free, aqueous ADW detergent compositions comprising potassium tripolyphosphate, formed by in-situ hydrolysis.

### BACKGROUND OF THE INVENTION

It is known that soluble, reversion-stable phosphate builders (such as sodium tripolyphosphate, potassium tripolyphosphate, mixed sodium potassium tripolyphosphate, etc.) can be used to prepare aqueous automatic dishwashing (ADW) detergent formulations for use in ADW appliances. Sodium tripolyphosphate builders, however, generally provide undesirable results. In particular, sodium tripolyphosphate has only limited solubility and has a tendency to increase cloudiness, reduce dispensability (e.g. excessive viscosity), and sometimes promote non-homogeneity (e.g. lumpiness) in aqueous ADW detergent compositions.

While commercially available, granular potassium tripolyphosphate builders are more soluble than their sodium counterparts, the cost of using substantially sodium ion-free potassium tripolyphosphate builders does not make it economically feasible to provide a reasonably priced, consumer-based aqueous ADW detergent product. Furthermore, the use of less expensive potassium orthophosphate and pyrophosphate builders in aqueous ADW detergent compositions are not nearly as effective in “building” detergent products as is potassium tripolyphosphate. Therefore, since methods of cleaning dishware using potassium tripolyphosphate in aqueous detergent compositions still remains uneconomical for most consumer product manufacturers as compared with the more commercially viable sodium tripolyphosphate, there remains a need for a more economical method of cleaning dishware using aqueous ADW detergent composition comprising potassium tripolyphosphate.

### SUMMARY OF THE INVENTION

The present invention relates to methods of improving dishware cleaning performance using an economical, substantially sodium ion-free, aqueous ADW detergent compositions and compositions of matter, having potassium tripolyphosphate that is prepared by in-situ hydrolysis.

In accordance with one aspect, a method of providing improved cleaning benefits using an economical, substantially sodium ion-free, aqueous ADW detergent composition is provided. The method comprises the steps of: (a) providing a substantially sodium ion-free, aqueous, ADW detergent composition comprising: (i) from about 20% to about 50% of potassium tripolyphosphate, by weight of the composition, that is prepared by in-situ hydrolysis according to the formula:
(KPO₃)₃+2 KOH→K₅P₃O₁₀+H₂O;
and (ii) optionally, at least one adjunct ingredient; and (b) contacting dishware in need of treatment with the ADW detergent composition in an automatic dishwashing appliance during at least some portion of the wash and/or rinse cycle. The composition may be in at least one or more of the following forms: liquids, liquigels, gels, foams, creams, and pastes.

In accordance with another aspect, an economical method of providing improved cleaning benefits using a composition of matter is provided. The method comprises the steps of: (a) providing a composition of matter comprising a wash liquor in an automatic dishwashing appliance comprising dishware in need of treatment, wherein the wash liquor comprises an aqueous ADW detergent composition having potassium tripolyphosphate that is prepared by in-situ hydrolysis according to the above formula; and (b) contacting the dishware with the potassium tripolyphosphate in an automatic dishwashing appliance during at least some portion of the wash and/or rinse cycle. The composition of matter may be substantially free of sodium ions. The wash liquor may provide from about 1,000 ppm to about 25,000 ppm of the potassium tripolyphosphate, by concentration.

### DETAILED DESCRIPTION

The present invention relates to domestic, institutional, industrial, and/or commercial methods of improving dishware cleaning performance using economical, substantially sodium ion-free, aqueous ADW detergent compositions and compositions of matter, having potassium tripolyphosphate that is prepared by in-situ hydrolysis. A substantially sodium ion-free, aqueous ADW detergent composition (hereinafter “aqueous ADW detergent composition”) having good dispensability and product clarity may be economically prepared using in-situ process methods.

It has surprisingly been found that when potassium trimetaphosphate is hydrolyzed under in-situ hydrolysis in the presence of potassium hydroxide, an inexpensive, substantially sodium ion-free, highly soluble potassium tripolyphosphate may be formed in a slurry mixture according to the following formula:
(KPO₃)₃+2 KOH→K₅P₃O₁₀+H₂O,
which can readily be used as detergent base or provided in part as a premix for preparing an aqueous ADW detergent composition at less cost than adding commercially-prepared, granular potassium tripolyphosphate directly. The term “KTMP” refers to potassium trimetaphosphate or (KPO₃)₃. The term “KTPP” refers to potassium tripolyphosphate or K₅P₃O₁₀.

In general, when KTPP is formed in-situ, the reaction may be carried out by slurrying the KTMP with water in a tank or mixing vessel. Potassium hydroxide (“KOH”) is added in solid or aqueous form. If the aqueous form is used, it should be initially heated to about 45° C. The rate of addition of the KOH should be controlled so that the temperature in the mixing vessel is between about 45° and about 120° C. Alternatively, the temperature may be between about 45° and about 115° C., between about 45° and about 110° C., between about 45° and about 105° C., between about 45° and about 100° C., between about 45° and about 90° C., between about 50° and about 80° C., or between about 60° and about 80° C. Once the KTMP and KOH are slurried into the mixing vessel, and the reaction completed, the adjunct ingredients are then added and mixed in any order desired. The resulting, aqueous ADW detergent composition (hereinafter “aqueous ADW detergent composition”) is then placed in an appropriate container or package (e.g. bottle, bag, dispenser, water-soluble pouch, gel pack, etc.) for eventual distribution and sale to the consumer. The units of the amounts provided are in weight % of the composition.

Control of the rate of hydration of the KTPP salt, when formed within the detergent slurry process, may be desirable. Generally, the higher the temperature of the aqueous mixture of KOH and KTMP, the faster is the rate of formation of the KTPP that results from the alkaline conversion of KTMP described in the formula above. The rate of conversion of KTMP to KTPP can be increased by increasing the ionic strength (concentration) of given detergent slurry. Thus, very high rates of conversion in the processes can advantageously be achieved by utilizing concentrated detergent slurries. The presence of more than about 0.5% wt. of potassium sulfate in the slurry (while the trimetaphosphate conversion reaction is being carried out) in some way may act as a catalyst for the conversion reaction, sometimes increasing the rate of conversion as much as 50% or more.

The amount of KOH utilized in the in-situ process will be an amount sufficient to furnish enough hydroxyl ions to the reaction so that at least a substantial amount or proportion (e.g., at least about 50%, at least about 55%, at least about 60%, at least about 65%, at least about 70%, at least about 75%, at least about 80%, at least about 85%, at least about 90%, at least about 95%, at least about 99%, and alternatively 100%) of the KTMP in the slurry can be converted into the corresponding KTPP.

Because two moles of hydroxyl ions are necessary to substantially convert one mole of KTMP to KTPP, the amount of the KOH that can be utilized (in the slurry) will generally be at least enough to furnish at least about one, at least about 1.1, at least about 1.2, at least about 1.3, at least about 1.4, at least about 1.5, at least about 1.6, at least about 1.7, at least about 1.8, at least about 1.9, at least about 2.0, and alternatively, at least about 2.1 mole equivalents of hydroxyl ions per mole of KTMP, which is present in the slurry. When substantially complete conversion of the KTMP is desired, the slurry should be formulated to contain at least about two moles of KOH per mole KTMP therein.

Any suitable amount of KTMP may be used herein to prepare any suitable amount of KTPP. In certain non-limiting embodiments, a suitable amount of KTMP that is converted during in-situ hydrolysis is that amount which provides from about 20% to about 50%, from about 20% to about 40%, and alternatively from about 25% to about 35% of potassium tripolyphosphate, by weight of the composition, after in-situ hydrolysis is substantially completed (e.g. 100% of the KTMP in the slurry is converted to KTPP). As stated above, the process described herein may provide any suitable amount of KTPP. Suitable amounts of KTPP prepared by in-situ hydrolysis include, but are not limited to: an amount from about 20% to about 50%, from about 20% to about 40%, and alternatively, from about 25% to about 35%, by weight of the composition.

The amount of water required to hydrate KTPP is calculated by the following chemical equation:
KTPP+6H2O→KTPP*6H₂O,
wherein the “KTPP*6H2O” represents potassium tripolyphosphate hexahydrate. For example, if the slurry mixture contains 20% by weight, KTPP, the total amount of water needed to substantially convert the KTPP to KTPP*6H2O is at least about 5.87%, by weight of the slurry. A detergent slurries may contain at least about 5.87% water, at least about 10% water, at least about 15% water, at least about 20% water, at least about 30% water, at least about 35% water, at least about 45% water, at least about 50% water, at least about 55% water, at least about 60% water, at least about 65% water, at least about 70% water, at least about 75% water, at least about 80% water, at least about 85% water, at least about 90% water, at least about 95% water, and alternatively at least about 99% water, based on the total weight of the completely formulated slurry mixture.

Any suitable amount of the slurry mixture may be used (such as, a detergent base or as a premix) to prepare the substantially sodium ion-free, aqueous ADW detergent composition. The slurry mixture may be used at 100% concentration and in combination with at least one adjunct ingredient to form the aqueous ADW detergent composition. However, any suitable dilution may be used herein. Suitable diluents may include, but are not limited to: carrier mediums and/or solvents, as described herein.

Any suitable amount of water may be used in the aqueous ADW detergent composition. In one non-limiting embodiment, the aqueous ADW detergent composition may comprise from about 5.87% to about 80% water, by weight of the composition. Alternatively, the aqueous ADW detergent composition may comprise from about 10% to about 70% water, from about 15% to about 60% water, from about 20% to about 50% water, from about 25% to about 50% water, from about 30% to about 50% water, and from about 35% to about 50% water, by weight of the composition.

Sodium ions may unintentionally be present as a raw material impurity and/or a contaminant. The expression “substantially free of sodium ions” means that the resulting, aqueous ADW detergent composition may have less than about 1% sodium ions present, by weight of the composition. In certain embodiments, the resulting, aqueous ADW detergent composition may comprise sodium ions in an amount less than about 0.1%, and alternatively, less than about 0.01%, by weight of the composition.

Viscosity and Yield Value

The aqueous ADW detergent composition herein may have any suitable viscosity and yield value. In one non-limiting embodiment, an aqueous ADW detergent composition that is to be dispensed from a container (e.g. bottle, multi-compartmental bottle, etc.) may have a viscosity in the range of from about 100 CPS to about 1,000,000 CPS, as measured herein with a Contravis Rheomat 115 viscometer utilizing a Rheoscan 100 controller and a DIN145 spindle at 25° C. Alternatively, the viscosity range may be from about 500 CPS to about 500,000 CPS, from about 1,000 CPS to about 100,000 CPS, from about 1,000 CPS to about 50,000 CPS, and from about 10,000 CPS to about 28,000 CPS. The yield value of the aqueous ADW detergent composition may be in the range of from about 20 to about 500, from about 50 to about 350, and alternatively from about 100 to about 250. The yield value is an indication of the shear stress at which the gel strength is exceeded and flow is initiated. It is measured herein with a Contravis Rheomat 115 viscometer utilizing a Rheoscan 100 controller and a DIN145 spindle at 25° C. The shear rate may rise linearly from 0 to about 0.4 inverse second over a period of 10 minutes after an initial 5-minute rest period.

In another non-limiting embodiment, an aqueous ADW detergent composition that is to be dispensed in the form of a unitized dose (e.g. gel pack, water-soluble pouch, multi-compartmental water-soluble pouch, and combinations thereof) may have a viscosity range at 1 inverse second of from about 100 CPS to about 1,000,000 CPS, from about 500 CPS to about 500,000 CPS, from about 1,000 CPS to about 100,000 CPS, from about 1,000 CPS to about 50,000 CPS, and alternatively, from about 1,000 CPS to about 20,000 CPS as measured herein with a Contravis Rheomat 115 viscometer utilizing a Rheoscan 100 controller and a DIN145 spindle at 25° C.

The aqueous ADW detergent composition herein may have any suitable pH. A suitable pH for at least some non-limiting embodiments may fall anywhere within the range of from about 7 to about 12, from about 8 to about 12, from about 9 to about 11.5, and alternatively from about 9 to about 11 as measured by a 1% aqueous solution. For example, certain embodiments of the aqueous ADW detergent composition have a pH of greater than or equal to about 7, greater than or equal to about 8, greater than or equal to about 9, greater than or equal to about 10, greater than or equal to about 11, and alternatively, equal to about 12, as measured by a 1% aqueous solution.

Optional Adjunct Ingredients

Any suitable adjunct ingredient in any suitable amount may be used in the aqueous ADW detergent composition. Suitable adjunct ingredients as described herein are substantially sodium ion-free. Suitable adjunct ingredients may include, but are not limited to: surfactants; suds suppressors; co-builders; enzymes; bleaching systems; thickening agents; dispersant polymers; solvents; anticorrosion agents; and mixtures thereof.

Other suitable adjunct ingredients may include, but are not limited to: potassium counter ions, such as, potassium salts including potassium chloride; enzyme stabilizers, such as calcium ion, boric acid, glycerine, propylene glycol, short chain carboxylic acids, boronic acids, and mixtures thereof; chelating agents, such as, alkali metal ethane 1-hydroxy diphosphonates (HEDP), alkylene poly (alkylene phosphonate), as well as, amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP); alkalinity sources; pH buffering agents, such as, amino acids, tris(hydroxymethyl)amino methane (TRIS), 2-amino-2-ethyl-1,3-propanediol, 2-amino-2-methyl-propanol, 2-amino-2-methyl-1,3-propanol, potassium glutamate, N-methyl diethanolamide, 1,3-diamino-propanol N,N′-tetra-methyl-1,3-diamino-2-propanol, N,N-bis(2-hydroxyethyl)glycine (bicine), N-tris (hydroxymethyl)methyl glycine (tricine), potassium carbonate, potassium polyphosphate, and organic diamines; water softening agents; secondary solubility modifiers; soil release polymers; hydrotropes; binders; carrier mediums, such as tap water, distilled water, deionized water; antibacterial actives, such as citric acid, benzoic acid, benzophenone, thymol, eugenol, menthol, geraniol, vertenone, eucalyptol, pinocarvone, cedrol, anethol, carvacrol, hinokitiol, berberine, ferulic acid, cinnamic acid, methyl salicylic acid, methyl salicylate, terpineol, limonene, and halide-containing compounds; detergent fillers, such as potassium sulfate; abrasives, such as, quartz, pumice, pumicite, titanium dioxide, silica sand, calcium carbonate, zirconium silicate, diatomaceous earth, whiting, and feldspar; anti-redeposition agents, such as organic phosphate; anti-oxidants; anti-tarnish agents, such as benzotriazole; anti-corrosion agents, such as, aluminum-, magnesium-, zinc-containing materials (e.g. hydrozincite and zinc oxide); processing aids; plasticizers (e.g. propylene glycol and glycerine); aesthetic enhancing agents, such as dyes, colorants, pigments, speckles, perfume, and oils; preservatives; and mixtures thereof.

As stated above, suitable adjunct ingredients may contain low levels of sodium ions by way of impurities or contamination. In certain non-limiting embodiments, adjunct ingredients may be present in an amount from about 0.0001% to about 99%, by weight of the composition.

Adjunct ingredients suitable for use are disclosed, for example, in U.S. Pat. Nos. 3,128,287; 3,159,581; 3,213,030; 3,308,067; 3,400,148; 3,422,021; 3,422,137; 3,629,121; 3,635,830; 3,835,163; 3,923,679; 3,929,678; 3,985,669; 4,101,457; 4,102,903; 4,120,874; 4,141,841; 4,144,226; 4,158,635; 4,223,163; 4,228,042; 4,239,660; 4,246,612; 4,259,217; 4,260,529; 4,530,766; 4,566,984; 4,605,509; 4,663,071; 4,663,071; 4,810,410; 5,084,535; 5,114,611; 5,227,084; 5,559,089; 5,691,292; 5,698,046; 5,705,464; 5,798,326; 5,804,542; 5,962,386; 5,967,157; 5,972,040; 6,020,294; 6,113,655; 6,119,705; 6,143,707; 6,326,341; 6,326,341; 6,593,287; and 6,602,837; European Patent Nos.: 0,066,915; 0,200,263; 0332294; 0414 549; 0482807; and 0705324; PCT Pub. Nos.: WO 93/08876; and WO 93/08874.

Surfactants

Any suitable surfactant in any suitable amount or form may be used herein. Suitable surfactants include anionic surfactants, cationic surfactants, nonionic surfactants, amphoteric surfactants, ampholytic surfactants, zwitterionic surfactants, and mixtures thereof.

Suitable nonionic surfactants are most typically used to confer improved water-sheeting action (especially on glassware) to the aqueous ADW product. Nonionic surfactants generally are well known, being described in more detail in Kirk Othmer's Encyclopedia of Chemical Technology, 3rd Ed., Vol. 22, pp. 360-379, “Surfactants and Detersive Systems”.

Suitable nonionic surfactants may be low-foaming surfactants having low cloud points. Suitable low cloud point surfactants may include polyoxyethylene block polymeric compounds and polyoxypropylene block polymeric compounds. Block polyoxyethylene-polyoxypropylene polymeric compounds include those based on ethylene glycol, propylene glycol, glycerol, trimethylolpropane and ethylenediamine as initiator reactive hydrogen compound. Certain of the block polymer surfactant compounds designated PLURONIC®, REVERSED PLURONIC®, and TETRONIC® by the BASF-Wyandotte Corp., Wyandotte, Mich., are also suitable in aqueous ADW detergent compositions described herein. Non-limiting examples include REVERSED PLURONIC® 25R2 and TETRONIC® 702. The low cloud point surfactant, described herein, may further have a hydrophile-lipophile balance (“HLB”; see Kirk Othmer hereinbefore) value within the range of from about 1 to about 10, alternatively from about 3 to about 8.

Suitable zwitterionic surfactants may be chosen from the group consisting of C₈ to C₁₈ (alternatively, C₁₂ to C₁₈) amine oxides and sulfo- and hydroxy-betaines, such as N-alkyl-N,N-dimethylammino-1-propane sulfonate where the alkyl group can be C₈ to C₁₈, alternatively C₁₀ to C₁₄. Suitable anionic surfactants may be chosen from alkylethoxycarboxylates, alkylethoxysulfates, with the degree of ethoxylation greater than 3 (alternatively from about 4 to about 10, or from about 6 to about 8), and chain length in the range of C₈ to C₁₆, alternatively in the range of C₁₁ to C₁₅.

Additionally, branched alkylcarboxylates have been found to be useful when the branch occurs in the middle and the average total chain length may be 10 to 18, alternatively 12-16 with the side branch 2-4 carbons in length. An example is 2-butyloctanoic acid. The anionic surfactant may be typically of a type having good solubility in the presence of calcium. Such anionic surfactants are further illustrated by sulfobetaines, alkyl(polyethoxy)sulfates (AES), alkyl (polyethoxy)carboxylates (AEC), and short chained C₆-C₁₀ alkyl sulfates and sulfonates.

Suitable surfactants may also encompass suitable polymeric materials in any suitable amount or form. Suitable polymeric materials may include, but are not limited to: non-silicone, phosphate, or non-phosphate polymers. These polymeric materials are known to defoam food soils commonly encountered in ADW processes. Suitable surfactants can also optionally contain propylene oxide in an amount up to about 15% by weight.

In certain non-limiting embodiments, a surfactant may be used in a surfactant system or mixed surfactant system comprising two or more distinct surfactants (such as, a charged surfactant selected from nonionic surfactants, zwitterionic surfactants, anionic surfactants, and mixtures thereof). Surfactants suitable for use are disclosed, for example, in U.S. Pat. Nos. 3,929,678; 4,223,163; 4,228,042; 4,239,660; 4,259,217; 4,260,529; and 6,326,341; EP Pat. No. 0414 549, EP Pat. No. 0,200,263, PCT Pub. No. WO 93/08876 and PCT Pub. No. WO 93/08874.

In certain non-limiting embodiments, the aqueous ADW detergent composition may comprise a surfactant in an amount from 0% to about 60%, from 1% to about 30%, from 2% to about 20%, from 2% to about 15%, from 2% to about 10%, and alternatively, from 2% to about 8% by weight of the composition.

Suds Suppressor

Any suitable suds suppressor in any suitable amount or form may be used herein. Suds suppressors suitable for use may be low-foaming and include low cloud point nonionic surfactants (as discussed above) and mixtures of higher foaming surfactants with low cloud point nonionic surfactants which act as suds suppressors therein (see EP Pat. No. 0705324, U.S. Pat. Nos. 6,593,287, and 6,326,341). In certain embodiments, one or more suds suppressors may be present in an amount from about 0% to about 30% by weight, or about 0.2% to about 30% by weight, or from about 0.5% to about 10%, and alternatively, from about 1% to about 5% by weight of composition.

Co-Builders

Any suitable co-builder may be used herein. Suitable co-builders include, but are not limited to: citrates, including, potassium citrate monohydrate; phosphates; nitrilotriacetates; ethylenediamintetraacetates; oxydisuccinates; mellitates; silicates; aluminosilicates; polycarboxylates, fatty acids, such as ethylene-diamine tetraacetate; and metal ion sequestrants, such as, aminopolyphosphonates, ethylenediamine tetramethylene phosphonic acid, and diethylene triamine pentamethylene-phosphonic acid; and mixtures thereof.

Substantially sodium ion-free builders may be disclosed in the following patents and publications: U.S. Pat. Nos. 3,128,287; 3,159,581; 3,213,030; 3,308,067; 3,400,148; 3,422,021; 3,422,137; 3,635,830; 3,835,163; 3,923,679; 3,985,669; 4,102,903; 4,120,874; 4,144,226; 4,158,635; 4,566,984; 4,605,509; 4,663,071; and 4,663,071; German Patent Application No. 2,321,001 published on Nov. 15, 1973; European Pat. No. 0,200,263; Kirk Othmer, 3rd Edition, Vol. 17, pp. 426-472 and in “Advanced Inorganic Chemistry” by Cotton and Wilkinson, pp. 394-400 (John Wiley and Sons, Inc.; 1972).

Enzyme

Any suitable enzyme and/or enzyme stabilizing system in any suitable amount or form may be used herein. Enzymes suitable for use include, but are not limited to: proteases, amylases, lipases, cellulases, peroxidases, and mixtures thereof. Amylases and/or proteases are commercially available with improved bleach compatibility.

Suitable proteolytic enzymes include, but are not limited to: trypsin, subtilisin, chymotrypsin and elastase-type proteases. Suitable for use herein are subtilisin-type proteolytic enzymes. Particularly preferred is bacterial serine proteolytic enzyme obtained from Bacillus subtilis and/or Bacillus licheniformis. Suitable proteolytic enzymes also include Novo Industri A/S ALCALASE®, ESPERASE®, SAVINASE® (Copenhagen, Denmark), Gist-brocades' MAXATASE®, MAXACAL® and MAXAPEM® 15 (protein engineered MAXACAL®) (Delft, Netherlands), and subtilisin BPN and BPN′(preferred), which are commercially available. Suitable proteolytic enzymes may include also modified bacterial serine proteases, such as those made by Genencor International, Inc. (San Francisco, Calif.) which are described in European Patent 251,446B, granted Dec. 28, 1994 (particularly pages 17, 24 and 98) and which are also called herein “Protease B”. U.S. Pat. No. 5,030,378, Venegas, issued Jul. 9, 1991, refers to a modified bacterial serine proteolytic enzyme (Genencor International), which is called “Protease A” herein (same as BPN′). In particular see columns 2 and 3 of U.S. Pat. No. 5,030,378 for a complete description, including amino sequence, of Protease A and its variants. Other proteases are sold under the tradenames: PRIMASE®, DURAZYM®, OPTICLEAN® and OPTIMASE®. In one non-limiting embodiment, a suitable proteolytic enzyme may be selected from the group consisting of ALCALASE® (Novo Industri A/S), BPN′, Protease A and Protease B (Genencor), and mixtures thereof.

In practical terms, the aqueous ADW detergent composition may comprise an amount up to about 5 mg, more typically about 0.01 mg to about 3 mg by weight, of active enzyme per gram of the composition. Protease enzymes may be provided as a commercial preparation at levels sufficient to provide from 0.005 to 0.1 Anson units (AU) of activity per gram of composition, or 0.01%-1% by weight of the enzyme preparation. For ADW purposes, it may be desirable to increase the active enzyme content in order to reduce the total amount of non-catalytically active materials delivered and thereby improve anti-spotting/anti-filming results. Examples of suitable enzymes are disclosed in the following patents and publications: U.S. Pat. Nos. 4,101,457; 5,559,089; 5,691,292; 5,698,046; 5,705,464; 5,798,326; 5,804,542; 5,962,386; 5,967,157; 5,972,040; 6,020,294; 6,113,655; 6,119,705; 6,143,707; and 6,602,837.

In certain embodiments, enzyme-containing, aqueous ADW detergent compositions, especially liquids, liquigels, and gels, may comprise from about 0.0001% to about 10%, or from about 0.005% to 8%, or from about 0.01% to about 6%, by weight of an enzyme stabilizing system. The enzyme stabilizing system can include any stabilizing agent that is compatible with the detersive enzyme. Suitable enzyme stabilizing agents can include, but are not limited to: calcium ions, boric acid, glycerine, propylene glycol, short chain carboxylic acid, boronic acid, and mixtures thereof.

Bleaching System

Any suitable bleaching system comprising any suitable bleaching agent in any suitable amount or form may be used herein. Suitable bleaching agents include, but are not limited to: halogenated bleaches and oxygen bleaches.

Any suitable oxygen bleach may be used herein. Suitable oxygen bleaches can be any convenient conventional oxygen bleach, including hydrogen peroxide. For example, perborate, e.g., potassium perborate (any hydrate, e.g. mono- or tetra-hydrate), potassium percarbonate, potassium peroxyhydrate, potassium pyrophosphate peroxyhydrate, potassium peroxide, or urea peroxyhydrate can be used herein. Organic peroxy compounds can also be used as oxygen bleaches. Examples of these are benzoyl peroxide and the diacyl peroxides. Mixtures of any convenient oxygen bleaching sources can also be used.

Any suitable halogenated bleach may be used herein. Suitable halogenated bleaches may include chlorine bleaches. Suitable chlorine bleaches can be any convenient conventional chlorine bleach. Such compounds are often divided in to two categories namely, inorganic chlorine bleaches and organic chlorine bleaches. Examples of the former are calcium hypochlorite, potassium hypochlorite, and magnesium hypochlorite. Examples of the latter are potassium dichloroisocyanurate, 1,3-dichloro-5,5-dimethlhydantoin, N-chlorosulfamide, chloramine T, dichloramine T, chloramine B, dichloramine T, N,N′-dichlorobenzoylene urea, paratoluene sulfondichoroamide, trichloromethylamine, N-chlorosuccinimide, N,N′-dichloroazodicarbonamide, N-chloroacetyl urea, N,N′-dichlorobiuret, and chlorinated dicyandamide.

The bleaching system may also comprise transition metal-containing bleach catalysts, bleach activators, and mixtures thereof. Bleach catalysts suitable for use include, but are not limited to: the manganese triazacyclononane and related complexes (see U.S. Pat. No. 4,246,612, U.S. Pat. No. 5,227,084); Co, Cu, Mn and Fe bispyridylamine and related complexes (see U.S. Pat. No. 5,114,611); and pentamine acetate cobalt (III) and related complexes (see U.S. Pat. No. 4,810,410) at levels from 0% to about 10.0%, by weight; and alternatively, from about 0.0001% to about 1.0%.

Typical bleach activators suitable for use include, but are not limited to: peroxyacid bleach precursors, precursors of perbenzoic acid and substituted perbenzoic acid; cationic peroxyacid precursors; peracetic acid precursors such as TAED, potassium acetoxybenzene sulfonate and pentaacetylglucose; pernonanoic acid precursors such as potassium 3,5,5-trimethylhexanoyloxybenzene sulfonate and potassium nonanoyloxybenzene sulfonate; amide substituted alkyl peroxyacid precursors (EP Pat. No. 0170386); and benzoxazin peroxyacid precursors (EP Pat. No. 0332294 and EP Pat. No. 0482807) at levels from 0% to about 10.0%, by weight; or from about 0.1% to about 1.0%.

Other bleach activators include substituted benzoyl caprolactam bleach activators. The substituted benzoyl caprolactams have the formula: 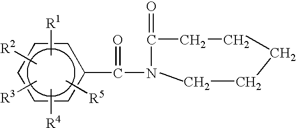
wherein R¹, R², R³, R⁴, and R⁵ contain from 1 to 12 carbon atoms, or from 1 to 6 carbon atoms and are members selected from the group consisting of H, halogen, alkyl, alkoxy, alkoxyaryl, alkaryl, alkaryloxy, and members having the structure: 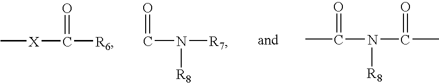
wherein R₆ is selected from the group consisting of H, alkyl, alkaryl, alkoxy, alkoxyaryl, alkaryloxy, and aminoalkyl; X is O, NH, or NR₇, wherein R₇ is H or a C₁-C₄ alkyl group; and R₈ is an alkyl, cycloalkyl, or aryl group containing from 3 to 11 carbon atoms; provided that at least one R substituent is not H. The R¹, R², R³, and R⁴ are H and R⁵ may be selected from the group consisting of methyl, methoxy, ethyl, ethoxy, propyl, propoxy, isopropyl, isopropoxy, butyl, tert-butyl, butoxy, tert-butoxy, pentyl, pentoxy, hexyl, hexoxy, Cl, and NO₃. Alternatively, R¹, R², R³ are H, and R⁴ and R⁵ may be selected from the group consisting of methyl, methoxy, and Cl.

In certain embodiments, the bleaching agent, bleach catalyst, and/or bleach activator may be encapsulated with any suitable encapsulant that is compatible with the aqueous ADW detergent composition and any bleach-sensitive adjunct ingredient (e.g. enzymes). For example, sulfate/carbonate coatings may be provided to control the rate of release as disclosed in UK Pat. No. GB 1466799.

Examples of suitable bleaching agents and bleaching systems may be disclosed in the following publications: GB-A-836988, GB-A-855735, GB-A-864798, GB-A-1147871, GB-A-1586789, GB-A-1246338, and GB-A-2143231. In other embodiments, the bleaching agent or bleaching system may be present in an amount from about 0% to about 30% by weight, or about 1% to about 15% by weight, or from about 1% to about 10% by weight, and alternatively from about 2% to about 6% by weight of composition.

Thickening Agent

Any suitable thickening agent in any suitable amount or form may be used herein. Suitable thickening agents include, but are not limited to polymeric thickening agents, such as cross-linked polycarboxylate polymers having a weight-average molecular weight of from about 500,000 to about 5,000,000, alternatively from about 750,000 to about 4,000,000, such as a polycarboxylate polymer (e.g. CARBOPOL® 980 from B.F. Goodrich); naturally occurring or synthetic clays; cellulose derivatives, natural gums (e.g. xanthum gum), and mixtures thereof.

The polycarboxylate polymer may be a carboxyvinyl polymer. Such compounds are disclosed in U.S. Pat. No. 2,798,053, issued on Jul. 2, 1957, to Brown. Suitable thickening agents may also include polyaspartates, carboxylated polysaccharides, particularly starches, celluloses and alginates, described in U.S. Pat. No. 3,723,322; the dextrin esters of polycarboxylic acids disclosed in U.S. Pat. No. 3,929,107; the hydroxyalkyl starch ethers, starch esters, oxidized starches, dextrins and starch hydrolysates described in U.S. Pat. No. 3,803,285; the carboxylated starches described in U.S. Pat. No. 3,629,121; and the dextrin starches described in U.S. Pat. No. 4,141,841.

Suitable cellulose thickening agents, described above, include, but are not limited to: cellulose sulfate esters (for example, cellulose acetate sulfate, cellulose sulfate, hydroxyethyl cellulose sulfate, hydroxypropyl methylcellulose methylcellulose sulfate, hydroxypropylcellulose sulfate, and mixtures thereof), potassium cellulose sulfate, carboxy methyl cellulose (e.g. QUATRISOFT® LM200), and mixtures thereof.

In other non-limiting embodiments, a thickener may be present in an amount from about 0.2% to about 5% of a thickening agent, alternatively from about 0.5% to about 2.5% of the compositions herein.

Dispersant Polymers

Any suitable dispersant polymer in any suitable amount may be used herein. Unsaturated monomeric acids that can be polymerized to form suitable dispersant polymers (e.g. homopolymers, copolymers, or terpolymers) include acrylic acid, maleic acid (or maleic anhydride), fumaric acid, itaconic acid, aconitic acid, mesaconic acid, citraconic acid and methylenemalonic acid.

Substantially non-neutralized forms of the polymer may also be used in the aqueous ADW detergent compositions. The weight-average molecular weight of the polymer can vary over a wide range, for instance from about 1000 to about 500,000, alternatively from about 1000 to about 250,000. Copolymers of acrylamide and acrylate having a weight-average molecular weight of from about 3,000 to about 100,000, or from about 4,000 to about 20,000, and an acrylamide content of less than about 50%, and alternatively, less than about 20%, by weight of the dispersant polymer can also be used. The dispersant polymer may have a weight-average molecular weight of from about 4,000 to about 20,000 and an acrylamide content of from about 0% to about 15%, by weight of the polymer. Suitable modified polyacrylate copolymers include, but are not limited to the low weight-average molecular weight copolymers of unsaturated aliphatic carboxylic acids disclosed in U.S. Pat. Nos. 4,530,766, and 5,084,535; and European Patent No. 0,066,915.

The presence of monomeric segments containing no carboxylate radicals (such as, methyl vinyl ether, styrene, ethylene, etc.) may be suitable provided that such segments do not constitute more than about 50% by weight of the dispersant polymer. Suitable dispersant polymers include, but are not limited to, those disclosed in U.S. Pat. Nos. 3,308,067; 3,308,067; and 4,379,080.

Suitable dispersant polymers also include water-soluble, sulfonated/carboxylated polymers comprising: (i) at least one carboxylic acid functionality; (ii) optionally, one or more nonionic functionality; and (iii) at least one sulfonate functionality, wherein the sulfonate functionality is less than 4 mole % of the molar content of the polymer.

Suitable sulfonated/carboxylated polymers may have a weight-average molecular weight of less than or equal to about 100,000 Da, or less than or equal to about 75,000 Da, or less than or equal to about 50,000 Da, or from about 10,000 Da to about 50,000, or from about 15,000 Da to about 50,000 Da; or from about 20,000 Da to about 50,000 Da, or alternatively, from about 25,000 Da to about 50,000 Da.

The sulfonated/carboxylated polymers may comprise (a) at least one structural unit derived from at least one carboxylic monomer having the general formula (I): 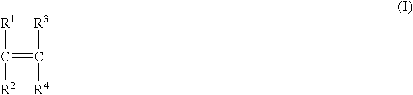
wherein R¹ to R⁴ are independently hydrogen, methyl, carboxylic acid group or CH2COOH and wherein the carboxylic acid groups can be neutralized; (b) optionally, one or more structural units derived from at least one nonionic monomer having the general formula (II): 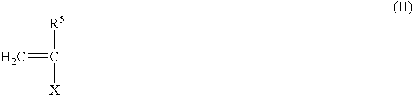
wherein R⁵ is hydrogen, C₁ to C₆ alkyl, or C₁ to C₆ hydroxyalkyl, and X is either aromatic (with R⁵ being hydrogen or methyl when X is aromatic) or X is of the general formula (III): 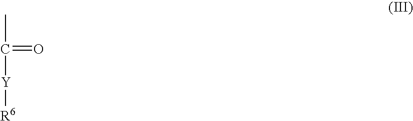
wherein R⁶ is (independently of R⁵) hydrogen, C₁ to C₆ alkyl, or C₁ to C₆ hydroxyalkyl, and Y is O or N; and at least one structural unit derived from at least one sulfonate monomer having the general formula (IV): 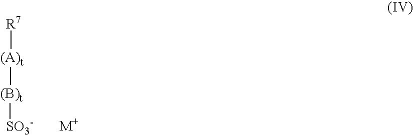
wherein R⁷ is a group comprising at least one sp² bond, A is O, N, P, S or an amido or ester linkage, B is a mono- or polycyclic aromatic group or an aliphatic group, each t is independently 0 or 1, and M⁺ is a cation. In one aspect, R⁷ is a C₂ to C₆ alkene. In another aspect, R⁷ is ethane, butene or propene. These water-soluble, sulfonated/carboxylated polymers are generally available from Alco (Nation Starch).

In certain non-limiting embodiments, a dispersant polymer may be present in an amount in the range from about 0.01% to about 25%, or from about 0.1% to about 20%, and alternatively, from about 0.1% to about 7% by weight of the composition.

Solvents

Any suitable solvent may be used in any suitable amount or form. Suitable solvents include ethers and diethers having from 4 to 14 carbon atoms, from 6 to 12 carbon atoms (alternatively from 8 to 10 carbon atoms), glycols or alkoxylated glycols, glycol ethers, alkoxylated aromatic alcohols, aromatic alcohols, and simple alcohols.

Suitable polyethylene glycols and polypropylene glycols may have a weight-average molecular weight of from about 950 to about 30,000. Such compounds for example, having a melting point within the range of from about 30° C. to about 100° C. can be obtained at weight-average molecular weights of 1450, 3400, 4500, 6000, 7400, 9500, and 20,000. Such compounds are formed by the polymerization of ethylene glycol or propylene glycol with the requisite number of moles of ethylene or propylene oxide to provide the desired weight-average molecular weight and melting point of the respective polyethylene and polypropylene glycol. The polyethylene, polypropylene, and mixed glycols are referred to using the formula:
HO(CH₂CH₂O)ₘ(CH₂CH(CH₃)O)ₙ(CH(CH₃)CH₂O)ₒH
wherein m, n, and o are integers satisfying the weight-average molecular weight and temperature requirements given above. Suitable polyethylene and polypropylene glycols can be obtained from the Dow Chemical Company of Midland, Mich.

In certain embodiments, a solvent may be present in an amount in the range from about 0.01% to about 70%, from about 0.1% to about 50%, from about 0.1% to about 20%, and alternatively, from about 0.1% to about 5% by weight of the composition.

Anti-Corrosion Agents

Any suitable polyvalent metal compound may be used in any suitable amount or form. Suitable polyvalent metal compounds include, but are not limited to: polyvalent metal salts, oxides, hydroxides, and mixtures thereof. Suitable polyvalent metals include, but are not limited to: Groups IIA, IIIA, IVA, VA, VA, VIIA, IIB, IIIB, IVB, VB and VIII of the Periodic Table of the Elements. For example, suitable polyvalent metals may include Al, Mg, Co, Ti, Zr, V, Nb, Mn, Fe, Ni, Cd, Sn, Sb, Bi, and Zn. These polyvalent metals may be used in their higher oxidation states.

Any suitable polyvalent metal salt may be used in any suitable amount or form. Suitable salts include but are not limited to: organic salts, inorganic salts, and mixtures thereof. For example, suitable polyvalent metal may include: water-soluble metal salts, slightly water-soluble metal salts, water-insoluble metal salts, slightly water-insoluble metal salts, and mixtures thereof. Examples of suitable polyvalent metal compounds include, but are not limited to: aluminum oxide, aluminum hydroxide, magnesium oxide, magnesium hydroxide, zinc oxide, zinc hydroxide, hydrozincite, and mixtures thereof.

In certain non-limiting embodiments, the level of polyvalent metal compound may be selected so as to provide from about 0.01% to about 60%, from about 0.02% to about 50%, from about 0.05% to about 40%, from about 0.05% to about 30%, from about 0.05% to about 20%, from about 0.05% to about 10%, and alternatively, from about 0.1% to about 5%, by weight, of the composition of polyvalent metal ions.

Method of Use

A typical ADW appliance uses between about 5 and about 7 Liters, alternatively about 6 Liters of main wash liquor per fill, into which the operator generally dispenses: from about 15 g to about 80 g; from about 15 g to about 60 g; from about 15 g to about 40 g; and alternatively, from about 20 g to about 30 g of the aqueous ADW detergent composition. A typical wash cycle takes approximately between about 60 and about 90 minutes depending on the quantity of dishware in the aqueous ADW appliance. The wash cycle generally consists of: (i) a pre-wash; (ii) a main wash cycle; (iii) a hot rinse cycle during which the rinse water is heated to a temperature of between about 50° C. and about 70° C.; (iv) optionally, additional hot rinse cycles; and (v) a drying cycle via air, heated air, or both. Examples of suitable ADW appliances include GE 2000 and Whirlpool 920.

Any suitable method of treating and/or cleaning dishware in an automatic dishwashing appliance with the aqueous ADW detergent composition and/or composition of matter described herein may be used to impart one or more of the benefits described herein during one or more of the wash and/or rinse cycles. In one non-limiting embodiment, the contacting of dishware may occur over any suitable amount or period of time, so long as dishware is contacted with at least some potassium tripolyphosphate described herein during at least some portion of the wash and/or rinse cycle. Suitable amounts or periods of time include, but are not limited to: from about 10 seconds to about 60 minutes; from about 30 seconds to about 45 minutes; from about 1 minute to about 30 minutes; from about 2 minutes to about 20 minutes; and alternatively from about 2 minutes to about 15 minutes.

In one non-limiting embodiment, a method of treating and/or protecting dishware is provided using an aqueous ADW detergent composition described herein. The method comprises the step of providing an aqueous ADW detergent composition comprising (i) an effective amount of potassium tripolyphosphate, by weight of the composition that is prepared by in-situ hydrolysis according to the formula
(KPO₃)₃+2 KOH==>K₅P₃O₁₀+H₂O,
and (ii) at least one adjunct ingredient; wherein said composition is substantially sodium-ion free; and contacting dishware in need of treatment in an automatic dishwashing appliance. The method may further comprise the step of dissolving the aqueous ADW detergent composition in wash liquor having a hardness of from about 1 to about 2 mmol/L in any suitable ADW appliance to provide a solution with an interfacial tension of less than about 4 Dynes/cm2, alternatively, less than about 2 Dynes/cm2, where the wash liquor has a temperature of less than about 45° C., less than about 40° C., and alternatively, less than about 35° C. The aqueous ADW detergent composition may be provided as a unitized dose.
Product Form

Any suitable product form or product forms in any combination may be used herein. Suitable product forms include, but are not limited to: liquids, liquigels, gels, foams, creams, pastes, and combinations thereof. Any suitable dispensing means may be used herein. Suitable dispensing means include dispensing baskets or cups, bottles (e.g. pump-assisted bottles, squeeze bottles, etc.), mechanical pumps, multi-compartment bottles, paste dispensers, capsules, tablets, multi-phase tablets, coated tablets, single- and/or multi-compartment water-soluble pouches, single- and/or multi-compartment water-soluble gel packs, and combinations thereof. The water-soluble pouches and water-soluble gel packs may be formed from water-soluble films selected from the group consisting of polyvinylalcohol (PVA), hydroxymethylcellulose (HPMC), and combinations thereof.

In one non-limiting embodiment, an aqueous ADW detergent composition may be provided as a unit dose (e.g. capsules, tablets, and/or pouches) to provide the consumer one or more of the following benefits: a proper dosing means, dosing convenience, specialized dishware treatment (i.e. improved cleaning performance, lower sudsing, tarnish protection for flatware, shine improvement, anti-corrosion protection, and/or tomato stain removal for plastic ware). In certain other non-limiting embodiments, the unit dose may provide a means to reduce negative interactions of incompatible components during the wash and/or rinse processes by allowing for the controlled release (e.g. delayed, sustained, triggered, slow release, etc.) of certain components of the aqueous ADW detergent composition. In certain non-limiting embodiments, a suitable unitized dose of the aqueous ADW detergent composition may, for example, contain: from about 15 g to about 80 g; from about 15 g to about 60 g; from about 15 g to about 40 g; and alternatively, from about 20 g to about 30 g of the aqueous ADW detergent composition.

A multi-compartment water-soluble pouch may comprise two or more incompatible components (e.g. bleach and enzymes) in separate compartments. The water-soluble pouch may be comprised of two or more water-soluble films defining two or more separate compartments. The two or more films may exhibit different dissolution rates in the wash liquor. One compartment may first dissolve and release a first component into the wash liquor up to 1 minute, up to 2 minutes, up to 3 minutes, up to 5 minutes, up to 8 minutes, up to 10 minutes, and alternatively up to 15 minutes faster in the wash liquor than the other compartment, which houses a second component that may be incompatible with the first component. In another non-limiting embodiment, a multi-phase product may comprise in a one compartment, the aqueous ADW detergent composition, described herein, and in a separate compartment of a multi-compartment water-soluble pouch, a solid detergent composition (e.g. powder, granules, capsules, and/or tablets).

The aqueous ADW detergent composition may also be packaged in any suitable manner or form, for example, as a kit, which may comprise a package comprising (a) the aqueous ADW detergent composition described herein; and (b) instructions for using the aqueous ADW detergent composition to treat dishware and provide a benefit (i.e. improved cleaning performance, lower sudsing, tarnish protection for flatware, shine improvement, anti-corrosion protection, and/or tomato stain removal for plastic ware), wherein the aqueous ADW detergent composition may be substantially sodium-ion free.

Compositions of Matter

Any suitable compositions of matter may be used herein in any suitable aqueous solution. Suitable aqueous solutions include, but are not limited to: hot and/or cold water, wash and/or rinse liquor, and combinations thereof. For example, suitable compositions of matter may comprise wash liquor of an ADW appliance, which contains the aqueous ADW detergent composition provided herein to treat and/or protect dishware and impart one or more of the benefits described above during the wash and/or rinse cycles.

One non-limiting embodiment is a composition of matter for treating dishware, comprises a wash liquor comprising an aqueous ADW detergent composition, having from about 1,000 ppm to about 25,000 ppm, or from about 1,000 ppm to about 20,000 ppm, or from about 1,000 ppm to about 15,000 ppm, from about 1,000 ppm to about 10,000 ppm, from about 1,000 ppm to about 8,000 ppm, and alternatively, from about 1,000 ppm to about 4,000 ppm, by concentration, of potassium tripolyphosphate, that is prepared by in-situ hydrolysis according to the formula:
(KPO₃)₃+2 KOH==>K₅P₃O₁₀+H₂O.
The compositions of matter are substantially free of sodium ions.
Process of Manufacture

Any suitable conventional detergent slurry process may be used to manufacture the aqueous ADW detergent compositions herein. For example, the aqueous ADW detergent composition of Example 1 may be prepared according to the following procedure: a slurry mixture is prepared in a separate jacket-lined mixing vessel by dispersing 20% wt. KTMP in 53.34% wt. water for about ten minutes at 100 rpm to 300 rpm mixing speed to form a slurry. Subsequently, 14.06% wt. of a 45% active KOH is added and reacted with the KTMP in-situ to form KTPP by hydrolysis. Optionally, the 45% active KOH is initially heated to about 45° C. prior to addition. Optionally, 0.5% wt. potassium sulfate is added to the mixture. Slurry mixing is continued for about ten minutes until the solids are dissolved.

Then, 7.0% wt. granular potassium silicate is added next to the main mixture and mixed for ten minutes at 300 rpm to 600 rpm mixing speed. Optionally, heat is applied by passing hot water or steam through the jacket during mixing, if required, to dissolve the silicate solids. Then, 1.2% wt. encapsulated potassium hypochlorite is dry blended in a separate vessel along with the 1% wt. nonionic surfactant (TETRONIC®) and the 2% wt. dye, pigments, speckles, and/or colorants to form a dry blend. This dry blend is then added to the mixing vessel to achieve a homogeneous dispersion in about two minutes of agitation at 100 rpm to 300 rpm mixing speed. Then, 0.5% wt. xanthum gum is then added to the mixing vessel to achieve viscosity of about 22,000 cps in the finished product in about ten minutes at 300 rpm to 600 rpm mixing speed.

The mixture is optionally cooled using a cold-water jacket. Then, 0.9% wt. perfume is added and dispersed in about 2 minutes at 100 rpm to 300 rpm mixing speed to form the resulting, aqueous ADW detergent composition, which is then placed in a bottle. Mixing times add up to about 44 minutes. Amounts are expressed in units of percent weight of the aqueous ADW detergent composition unless otherwise noted.

### EXAMPLES

The following examples of aqueous ADW detergent compositions are provided for purposes of showing certain embodiments, and as such are not intended to be limiting in any manner.

| | EXAMPLES | | | | | |
|---|---|---|---|---|---|---|
| Ingredients | 1 | 2 | 3 | 4 | 5 | 6 |
| KTMP | 20 | 20 | 25 | 25 | 33.19 | 33.19 |
| Hydrozincite | — | 0.2 | — | 0.2 | — | 0.2 |
| Potassium hydroxide | 7.32 | 10 | 9.15 | 12 | 23.35 | 23.35 |
| Potassium silicate | 7.0 | 7.0 | 7.0 | 7.0 | — | — |
| Potassium citrate | — | — | — | — | — | 12.70 |
| Thickener¹ | 0.5 | — | 0.5 | — | — | — |
| Thickener² | — | 0.6 | — | 0.6 | 0.6 | 0.6 |
| Potassium hypochlorite | 1.2 | 1.2 | 1.2 | 1.2 | — | — |
| Encapsulated potassium | — | — | — | — | 1.2 | — |
| hypochlorite | | | | | | |
| Nonionic surfactant³ | 1.0 | — | — | 1.0 | — | — |
| Nonionic surfactant⁴ | — | 1.0 | 1.0 | — | 1.0 | 1.0 |
| Protease enzyme | — | — | — | — | 1.0 | 1.0 |
| Amylase enzyme | — | — | — | — | 0.2 | 0.2 |
| Enzyme stabilizing agents | — | — | — | — | 2.0 | 3.5 |
| dye, pigments, speckles, | 0.2 | 0.2 | 0.2 | 0.2 | 0.2 | 0.2 |
| and/or colorants | | | | | | |
| Perfume | 0.16 | 0.16 | 0.16 | 0.16 | 0.16 | 0.16 |
| Water | Balance | Balance | Balance | Balance | Balance | Balance |

¹xanthum gum
²CARBOPOL ® 980 by B.F. Goodrich.
³POLY-TERGENT ® SLF-18B by Olin Corporation
⁴TETRONIC ® by the BASF-Wyandotte Corp.

With reference to the polymers described herein, the phrase “weight-average molecular weight” is the weight-average molecular weight as determined using gel permeation chromatography according to the protocol found in Colloids and Surfaces, Physico Chemical & Engineering Aspects, Vol. 162, 2000, pg. 107-121. The units are Daltons.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of providing improved cleaning benefits in an automatic dishwashing appliance, said method comprising the steps of:
(a) providing a substantially sodium ion-free, aqueous ADW detergent composition comprising:
(i) from about 20% to about 50% of potassium tripolyphosphate, by weight of the composition, that is prepared by in-situ hydrolysis according to the formula:
(KPO₃)₃+2 KOH→K₅P₃O₁₀+H₂O; and
(ii) optionally, at least one adjunct ingredient; and
(b) contacting dishware in need of treatment with the ADW detergent composition during at least some portion of the wash and/or rinse cycle.

2. The method according to claim 1 wherein the amount of said potassium trimetaphosphate, (KPO₃)₃, converted during said in-situ hydrolysis, provides from about 20% to about 50% of said potassium tripolyphosphate by weight of the composition.

3. The method according to claim 2 wherein the amount of said potassium trimetaphosphate, (KPO₃)₃, converted during said in-situ hydrolysis, provides from about 20% to about 40% of potassium tripolyphosphate, by weight of the composition.

4. The method according to claim 1, wherein said composition comprises an adjunct ingredient selected from the group consisting of: surfactants, suds suppressors, co-builders, sequestrants, bleaching agents, bleach activators, bleach catalysts, enzymes, enzyme stabilizers, thickening agents, chelating agents, alkalinity sources, pH buffering agents, water softening agents, secondary solubility modifiers, soil release polymers, dispersant polymers, hydrotropes, fillers, binders, carrier mediums, oils, organic solvents, antibacterial actives, abrasives, anti-redeposition agents, anti-tarnish agents, anti-corrosion agents, processing aids, plasticizers, aesthetic enhancing agents, preservatives, and mixtures thereof.

5. The method according to claim 4, wherein said surfactant is selected from the group consisting of anionic surfactants, cationic surfactants, nonionic surfactants, amphoteric surfactants, ampholytic surfactants, zwitterionic surfactants, and mixtures thereof.

6. The method according to claim 4, wherein said co-builder is selected from the group consisting of citrates, phosphates, nitrilotriacetates, ethylenediamintetraacetates, oxydisuccinates, mellitates, silicates, aluminosilicates, polycarboxylates, fatty acids, and metal ion sequestrants, and mixtures thereof.

7. The method according to claim 4, wherein said enzyme is selected from the group consisting of proteases, amylases, lipases, cellulases, peroxidases, and mixtures thereof

8. The method according to claim 4, wherein said bleaching agent is selected from the group consisting of halogenated bleach, oxygen bleach, and mixtures thereof.

9. The method according to claim 8, wherein said bleaching agent is encapsulated.

10. The method according to claim 9, wherein said bleaching agent is potassium hypochlorite.

11. The method according to claim 4, wherein said thickening agent is selected from the group consisting of cross-linked polycarboxylate polymers having a weight-average molecular weight of from about 500,000 to about 5,000,000, naturally occurring or synthetic clays, cellulose derivatives, natural gums, starches, alginates, and mixtures thereof.

12. The method according to claim 4, wherein said dispersant polymer is selected from the group consisting of acrylic acid, maleic acid, fumaric acid, itaconic acid, aconitic acid, mesaconic acid, citraconic acid, methylenemalonic acid, polyaspartate, carboxylated polysaccharides, and mixtures thereof.

13. The method according to claim 4, wherein said solvent is selected from the group consisting of ethers and diethers having from 4 to 14 carbon atoms, glycols or alkoxylated glycols, glycol ethers, alkoxylated aromatic alcohols, aromatic alcohols, simple alcohols, and mixtures thereof.

14. The method according to claim 1, wherein said composition is provided in the form of a unit dose selected from the group consisting of single-compartment water-soluble pouches, multi-compartment water-soluble pouches, single-compartment water-soluble gel packs, multi-compartment water-soluble gel packs, and combinations thereof, and wherein said composition is in at least one or more of the following forms: liquids, liquigels, gels, foams, creams, and pastes.

15. The method according to claim 14, wherein said water-soluble pouches and water-soluble gel packs are made from films selected from the group consisting of polyvinylalcohol (PVA), hydroxymethylcellulose (HPMC), and combinations thereof.

16. The method according to claim 1, wherein the pH of said composition is from about 7 to about 12

17. The method according to claim 1, wherein said composition comprises from about 5.87% to about 80% water.

18. The method according to claim 1 wherein said composition is provided in the form of a kit, wherein said kit comprises a package comprising:
(a) the composition according to claim 1; and
(b) instructions for use of said composition to treat dishware and provide a benefit.

19. The method according to claim 18, wherein said composition is provided in the form of a unit dose selected from the group consisting of single-compartment water-soluble pouches, multi-compartment water-soluble pouches, and combinations thereof; and wherein said composition is in at least one or more of the following forms: liquids, liquigels, gels, foams, creams, and pastes.

20. A method of providing improved cleaning performance using a composition of matter, said method comprises the steps of:
(a) providing a composition of matter comprising a wash liquor in an automatic dishwashing appliance comprising dishware in need of treatment, wherein said wash liquor comprises:
(i) a potassium tripolyphosphate builder that is prepared by in-situ hydrolysis according to the formula:
(KPO₃)₃+2 KOH→K₅P₃O₁₀+H₂O, and
(ii) at least one adjunct ingredient; and
(b) contacting said dishware with said potassium tripolyphosphate during at least some portion of the wash and/or rinse cycle.

21. The method according to claim 20 wherein said wash liquor is substantially sodium-ion free.

22. The method according to claim 20 wherein said wash liquor comprises from about 1,000 ppm to about 25,000 ppm of said potassium tripolyphosphate, by concentration.

23. The method according to claim 20 wherein said contact step is from about 10 seconds to about 60 minutes.

24. The method according to claim 20, after step (a) further comprising the step of dissolving the aqueous ADW detergent composition in wash liquor having a hardness of from about 1 to about 2 mmol/L; wherein said wash liquor has an interfacial tension of less than about 4 Dynes/cm2; and wherein said wash liquor has a temperature of less than about 45° C.

25. The method according to claim 24, wherein said wash liquor has an interfacial tension of less than about 2 Dynes/cm2

26. The method according to claim 24, wherein said wash liquor a temperature of less than less than about 40° C.

27. The method according to claim 26, wherein said wash liquor a temperature of less than less than about 35° C.
